(19) United States
(12) Patent Application Publication
(10) Pub. No.: US 2006/0265361 A1
(43) Pub. Date: Nov. 23, 2006

(54) Intelligent search agent

(76) Inventor: William W.Y. Chu, Los Altos, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/254,292

(22) Filed: Oct. 19, 2005

Related U.S. Application Data
(60) Provisional application No. 60/683,583, filed on May 23, 2005.

(51) Int. Cl. G06F 17/30

(52) U.S. Cl. 707/3

(57) ABSTRACT

With the proliferation of travel websites, users must separately search competing travel websites to find a travel service that satisfies their travel preferences. A travel agent is provided for automatically searching multiple travel websites for travel services satisfying search criteria that are based on a user's travel preferences. The travel agent implements a search strategy to automatically access, navigate, and parse one or more travel websites, enter search parameters, and extract data associated with relevant travel services. The travel agent can execute on a user's personal computer to harness the computational power of the personal computer and reduce the burden on centralized servers that search for travel services. Moreover, by storing a user's travel preferences on the same personal computer, the travel agent reduces access times to user data and protects it from insecurities associated with transmission over a network.

### CROSS-REFERENCE TO RELATED APPLICATION

This application claims the benefit of U.S. Provisional Application No. 60/683,583, filed May 23, 2005, which is hereby incorporated by reference herein.

### BACKGROUND OF THE INVENTION

1. Field of the Invention

This invention pertains in general to a computerized search agent for searching for information on a network and in particular to a search agent for searching Internet web sites for travel-related information.

2. Description of the Related Art

Travel websites allow a user to search for travel services such as flights, hotel rooms, car rentals, and vacation packages. Travel websites execute searches using a server that searches a database of available travel services for a travel service meeting user requirements. For example, to make an airline reservation, a user accesses a travel website, where he enters a number of travelers, a departure location, a destination, and a date for travel. The travel website sends the user's search request to a server, which searches a database of available flights and returns prices and schedules of flights meeting the user's requirements. Conventional travel websites allow a user to search for travel services meeting a limited number of user requirements, but are incapable of searching for travel services satisfying a variety of user preferences, such as a hotel with a fitness center, airport shuttle service or an internet connection.

Commercial travel websites such as EXPEDIA, ORBITZ and TRAVELOCITY act like agents for travel service providers such as airlines, hotels and car rental companies. Travel service providers pay commercial travel websites a commission per reservation performed through the travel website. Travel service providers also operate their own retail websites to sell travel services directly to a user, thereby avoiding the commissions paid to commercial websites like EXPEDIA or ORBITZ.

Conventional travel websites rely on centralized servers to manage and perform searches in large and cumbersome databases. Personal computers are used merely to interface with a user by providing a web browser for data entry and presentation of results. However, conventional travel websites fail to harness the computing power of a personal computer to search for travel services because the search is not managed or performed by a personal computer. Conventional travel websites are also deficient in that they store only limited types of user information, such as login information, addresses, existing reservations and credit card information. Other types of information such as a preferred airline or seat location may need to be re-entered each time a user searches for or reserves a travel service. Moreover, user information is stored in network databases that are remote from the user's personal computer. Remote storage of information compromises its security, increases access time and requires large amounts of storage space in network databases.

With the proliferation of travel websites, a user needs to separately search a large number of competing travel websites to find a travel service that satisfies his requirements. To find a suitable travel service, a user must repeatedly perform the tedious, manual tasks of website navigation, data entry and reviewing the details of each travel service that fits the user's schedule. Further, the proliferation of travel websites provides a variety of sources and techniques to search for a travel service. Different websites present different techniques for efficient searching and provide access to services from various travel service providers. However, a user may lack the time or experience to efficiently search the various travel websites for a travel service. Accordingly, what is needed are techniques by which a user can readily invoke a search on multiple travel websites.

A recent development in travel websites, known as a travel search engine, is able to trawl the listings of various retail websites. Rather than searching a database of travel services, travel search engines scour multiple airline, hotel and car rental websites to search for travel services that meet a user's requirements. Matching results are presented to a user, who is directed to the retail website to complete the reservation. One problem with travel search engines is that they are unable to trawl a retail website without the website owner's permission. Commercial travel websites, in particular, block travel search engines from accessing their inventory. Accordingly, travel search engines are unable to serve as a one-stop shop for travel services.

Techniques are needed for automatically searching multiple travel websites for travel services that meet a variety of user preferences. A variety of travel websites, including commercial travel websites as well as retail websites, need to be searched without being blocked by website owners. Each travel website should be searched efficiently using techniques specifically designed for searching the particular travel website. While searching for a travel service, there is also a need to improve security of a user's travel preferences, reduce access times and alleviate storage space requirements in network databases.

### BRIEF SUMMARY OF THE INVENTION

The above needs are met by a travel agent capable of automatically searching multiple travel websites for travel services satisfying search criteria that are based on a user's travel preferences. The travel agent selects and implements a search strategy to efficiently search the travel websites for travel services satisfying the search criteria. Each search strategy identifies one or more travel websites and provides navigation information for efficiently searching the travel websites, including information for accessing, navigating, and parsing the travel websites, entering search parameters, and extracting data associated with travel services from the travel websites. In one embodiment, search strategies can be created by experts and can provide techniques for simulating a user's navigation of a travel website.

Each travel agent can execute on a user's personal computer to harness the computational power of the personal computer, thereby eliminating the need for centralized servers that search for travel services. By storing a user's travel preferences on the user's personal computer, the travel agent can also reduce access times to user data and protects it from insecurities associated with transmission over a network. Other features of the travel agent include repeatedly searching travel websites to track the current information associated with a travel service; presenting a user with target advertisements; and generating a unified travel itinerary for travel services found at different travel websites.

### BRIEF DESCRIPTION OF THE DRAWINGS

FIG. 1 is a high-level block diagram illustrating a typical environment used to search for travel services according to one embodiment.

FIG. 2 is a high-level block diagram showing a more detailed view of modules within a client computer in a travel service search environment, according to one embodiment.

FIG. 3 is a high-level block diagram illustrating a more detailed view of a travel agent according to one embodiment.

FIG. 4 is a high-level block diagram illustrating a more detailed view of a search module according to one embodiment.

FIG. 5 is a high-level block diagram showing a more detailed view of modules within a travel server, according to one embodiment.

FIG. 6 is a flow chart illustrating steps performed by a travel agent to search for travel services according to one embodiment.

FIG. 7 is a flow chart illustrating steps performed by a travel agent to provide target advertising according to one embodiment.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

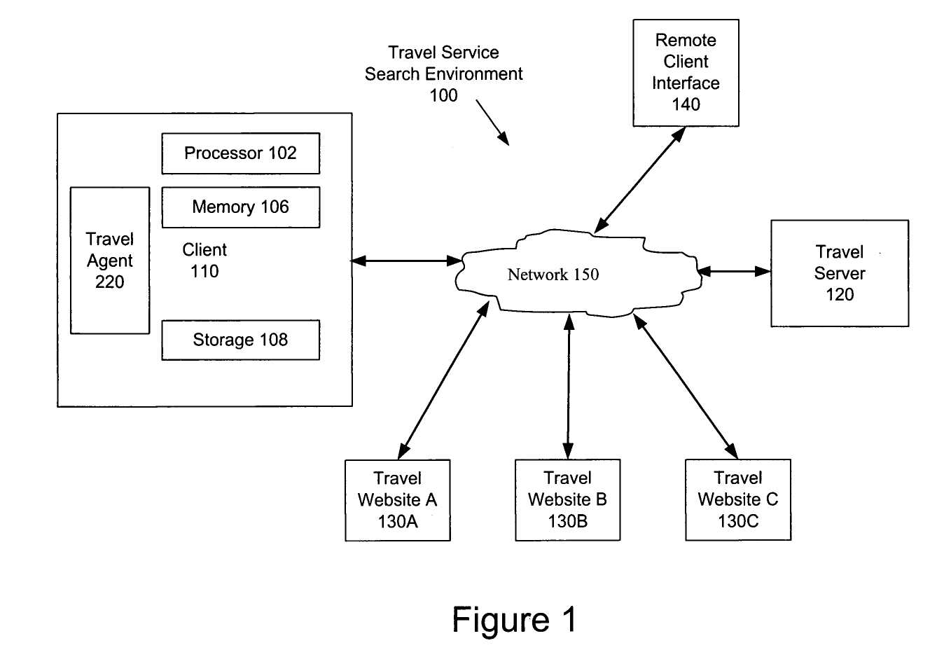

FIG. 1 is a high-level block diagram illustrating a typical environment 100 used to search for travel services according to one embodiment. The environment 100 includes a client 110 in communication with multiple travel websites 130, a travel server 120 and a remote client interface 140 via a network 150. Client 110 comprises a travel agent 220 that automatically searches travel websites 130 for travel services satisfying search criteria that are based on user preferences. In one embodiment, a user of travel agent 220 can be a human user, and client 110 can be the user's personal computer. A personal computer is a computing device that is owned or operated by a user and that is capable of satisfying the user's computing needs. A personal computer is typically located near a user, such as at the user's home or office, and can be used to communicate with remote web servers over a network. Note that the remote web servers are typically operated by entities other than the user. Examples of a personal computer include a laptop, desktop, PDA, or other personal device capable of implementing travel agent 220. Only three client travel websites 130 are shown in FIG. 1 for purposes of clarity, but those of skill in the art will recognize that typical environments 100 can include numerous travel websites 130, and can also have multiple clients 110, travel servers 120 and remote client interfaces 140. There can also be other computers connected to network 150 beyond those shown in FIG. 1.

FIG. 1 and the other figures use like reference numerals to identify like elements. A letter after a reference numeral, such as “130A,” indicates that the text refers specifically to the element having that particular reference numeral. A reference numeral in the text without a following letter, such as “130,” refers to any or all of the elements in the figures bearing that reference numeral (e.g. “130” in the text refers to reference numerals “130A,” “130B,” and/or “130C” in the figures).

The network 150 enables data communication between and among the entities shown in FIG. 1 and in one embodiment is the Internet. In another embodiment, the network 150 is a local area network (LAN) or wide area network (WAN) operated by an enterprise and coupled to the Internet. In one embodiment, the network 150 uses standard communications technologies and/or protocols. Thus, the network 150 can include links using technologies such as Ethernet, 802.11, integrated services digital network (ISDN), digital subscriber line (DSL), asynchronous transfer mode (ATM), etc. Similarly, the networking protocols used on the network 150 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 150 can be represented using technologies and/or formats including the hypertext markup language (HTML), the extensible markup language (XML), the simple object access protocol (SOAP) etc. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

A travel service refers to any type of travel-related product, service, or information associated with travel. Illustrative examples of travel services include flights, hotel rooms, car rentals, vacation packages, travel luggage, sports accessories, and guidebooks.

Travel website 130 comprises any website, now known or later developed, that provides information about travel services. Well known types of travel websites 130 include commercial travel websites, travel search engines, travel bidding websites such as PRICELINE, retail websites operated by travel service providers, travel service search and user review websites such as MYTRAVELGUIDE, and specialty travel websites such as TRAVELZOO. Exemplary travel website 130A includes various input fields, such as a text box, a check box and a drop down menu, for inputting user requirements when searching for a travel service. For example, a user inputs his departure and destination airport and the dates of travel in these input fields. Note that travel website 130A may also allow a user to enter various other types of information such as desired time of flight, and whether to search for airports within 80 miles of the selected airport. Other exemplary fields in a travel website 130 include links to web pages providing information about travel services, or fields of a search result that provide information associated with a travel service. Travel website 130A searches for a travel service that satisfies the requirements inputted by the user, and displays retrieved results to the user. Another exemplary travel website 130B, such as TRAVELZOO, allows users to browse through special deals in different categories, for example Vacation Specials in Hawaii.

Travel Server 120 stores search strategies for searching travel websites 130 as well as advertising data used for target advertising. Each search strategy provides a plan for finding travel services satisfying a particular set of search criteria. In particular, each search strategy identifies one or more travel websites 130 that should be searched to efficiently find travel services satisfying a particular set of search criteria. Each search strategy also provides navigation information for efficiently searching each identified travel website 130, including information for accessing, navigating, and parsing the travel website 130, entering search parameters, and extracting data associated with a travel service from the travel website 130. In one embodiment, travel agent 220 is downloaded to client 110 from a server through the Internet, and search strategies from travel server 120 are downloaded to client 110 to be used by travel agent 220. In one embodiment, the navigation information provided by a search strategy enables travel agent 220 to simulate a user's navigation of a travel website 130, wherein travel agent 220 can simulate user navigation in a manner that is indistinguishable from a human user's interaction with a travel website 130. For example, a travel agent 220 uses the navigation information to emulate a user's keyboard or mouse inputs for the purpose of extracting relevant information from a travel website 130. Search strategies stored in travel server 120 are updated by experts to reflect changes in travel websites 130. Similarly, advertising data in travel server 120 is periodically updated to reflect changes in advertisement data.

In one embodiment, client 110 is a computer adapted to execute computer programs. One skilled in the art will recognize that client 110 comprises any computer capable of implementing a travel agent that searches travel websites for travel services satisfying a search criteria. For example, client 110 can be a personal computer such as a laptop or desktop, a cell phone, or a personal digital assistant. The computer programs, associated data, and/or functional components of the programs are referred to herein as “modules.” In one embodiment, the modules are stored as executable files on client 110, although modules can also be stored in hardware and/or firmware. When utilized, the modules are loaded into the memory 106 and executed by the processor 102.

Client 110 is adapted to search multiple travel websites 130 for travel services that satisfy a set of search criteria. Upon receiving a user's request to search for a travel service, client 110 requests the user to specify his or her preferences for the travel service. Alternatively, client 110 retrieves the user's preferences from memory 106 or from a user preferences module 232 that can be stored in storage 108. Storage 108 represents any type of data storage, such as flash memory or a mass storage device, e.g. a hard drive. For example, the user preferences are stored locally at a user's personal computer, such as on the hard drive of the user's personal computer or on a flash drive in communication with the user's personal computer. The user's preferences are used to generate search criteria. Examples of search criteria are a departure date for a flight reservation, and a location for a hotel reservation. Based on the search criteria, client 110 selects one or more search strategies for searching travel websites 130. In one embodiment, search strategies are downloaded at client 110 from travel server 120. Search strategies downloaded at client 110 can be stored in search strategies module 250. For example, the downloaded search strategies are stored locally at a user's personal computer, such as in the hard drive of the user's personal computer or on a flash drive in communication with the user's personal computer. To perform a search, travel agent 220 retrieves the one or more search strategies from search strategies module 250. Client 110 implements the search strategies to search multiple travel websites 130 for travel services satisfying the search criteria.

The remote client interface 140 resides on a device remote from client 110, such as a cell phone or personal digital assistant, which is capable of communicating with client 110 over the network 150. For example, remote client interface 140 is a web browser on a cell phone. In one embodiment, remote client interface 140 communicates with client 110 to provide a user's request to search for a travel service. Search criteria for the request may be specified via remote client interface 140 or may alternately be retrieved from memory 106 in client 110. Note that the search request from remote client interface 140 can be sent to client 110 directly or alternatively through an intermediate server that provides secure communication to client 110. In one embodiment, the intermediate server authenticates a user of remote client interface 140 before sending the search request to client 110. Alternatively, when the search request is sent to client 110 directly, client 110 supports user authentication. For example, a user can use a cell phone to send a search request to an intelligent travel agent 220 residing on a personal computer.

After client 110 performs the requested search, travel services satisfying the search criteria are transmitted to remote client interface 140, either directly or securely through the intermediate server. In one embodiment, these search results are tailored for accessing them via remote client interface 140. For example, the search results may be compressed and simplified to facilitate viewing on a cell phone. Note that search results can be tailored for remote client interface 140 by various devices, such as client 110, an intermediate server, or by the device on which the remote client interface 140 resides. Alternatively, client 110 sends search results to remote client interface 140 via email.

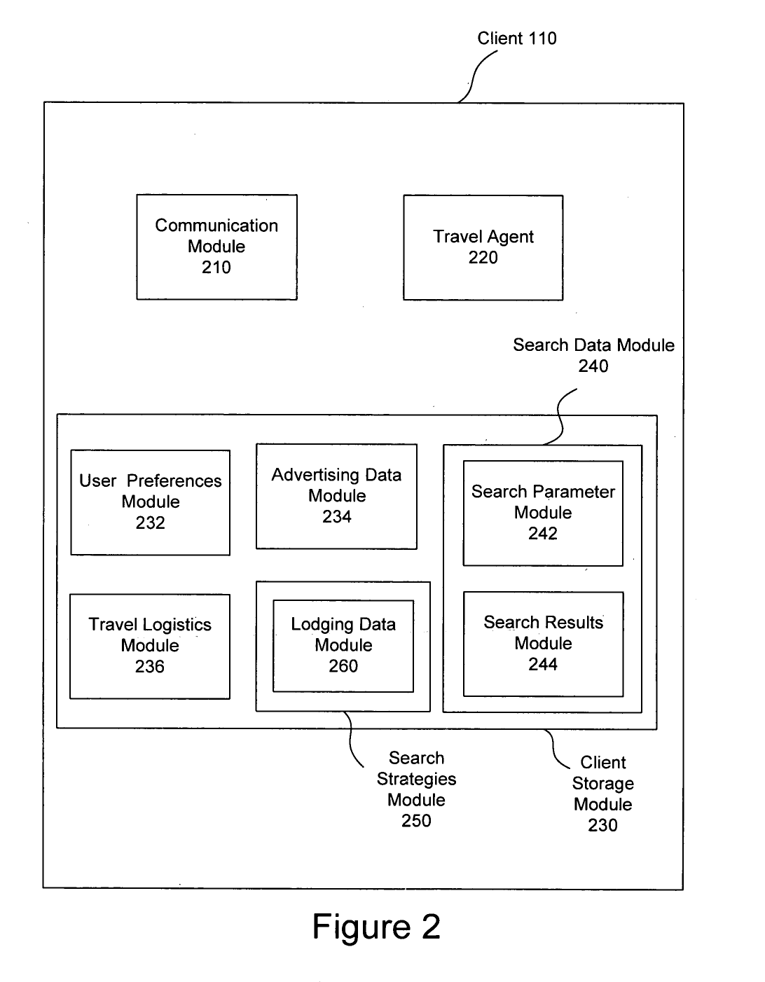

FIG. 2 is a high-level block diagram showing a more detailed view of modules within a client computer 110 in a travel service search environment 100, according to one embodiment. Client 110 includes travel agent 220, communication module 210 and client storage module 230.

In response to a user's request to search for travel services, travel agent 220 generates search criteria based on the user's preferences, selects a search strategy for finding travel services satisfying the search criteria, and implements the search strategy to automatically search one or more travel websites 130 for desired travel services. Various components and functionality of travel agent 220 are described in further detail below.

Communication module 210 provides an interface to travel agent 220. Travel agent 220 uses communication module 210 to interact with users. Communication module 210 may interact with users via a graphical user interface for travel agent 220. For example, communication module 210 receives a user's request to search for travel services. Travel agent 220 also uses communication module 210 to interact with entities on network 150, such as remote client interface 140, travel server 120, and travel websites 130. For example, communication module 210 downloads search strategies from travel server 120 to client 110.

Client 110 also includes client storage module 230 for storing various types of data associated with travel agent 220. In one embodiment, client storage module 230 stores data in memory 106. Alternatively, client storage module 230 stores data in storage 108. Client storage module 230 includes a user preferences module 232 for storing and retrieving travel preferences of one or more users. Access to user's travel preferences can be protected by a password or other form of user authentication. A user's travel preferences are used to generate search criteria while searching travel websites 130 for a travel service. User preferences module 232 is capable of storing a wide range of travel preferences, such as hotel preferences, airline and airport preferences, and recreational activity preferences. By using the large number of travel preferences stored in user preferences module 232, client 110 is able to search for travel services that are particularly well suited to a user's needs.

User travel preferences that remain constant across different trips need not be re-entered by a user for each search because they are conveniently stored in user preferences module 232. Examples of travel preferences that typically remain constant include a preferred airline or airlines to avoid, availability and transferability of mileage awards, preferred airports, connecting airports to avoid during certain seasons, a preferred class of travel based on flight duration or whether the flight is domestic or international, preferred arrival and departure times, a desired price range, a preferred seating choice, preferred international travel visa requirements, hotel room preferences such as smoking or non-smoking, free airport shuttles to a hotel, preferred car rental companies, and a type of car desired. Examples of user preferences that may vary with each trip include a flexible range of travel dates to obtain a lower fare, a number of travelers, flights allowing upgrades based on mileage awards, avoiding non-cancelable flights or connections between different types of airlines, whether the desired flight reservation is for one way, round trip or multiple segments, the maximum number of connecting flights, and whether certain types of travel websites 130 such as auction-based sites should be included in a search.

Travel preferences can be acquired from a user in a variety of ways, such as by allowing the user to select preferences from a list, requesting the user to supply answers to a questionnaire, or based on travel preferences specified in a user's previous search requests using a travel agent 220 or a travel website 130. In one embodiment, user preferences module 232 is capable of ranking travel preferences according to priority. A user's travel preferences can be ranked in a default order that may be changed by the user. For example, a user may specify that an internet connection at a hotel is a MUST while an airport shuttle to the hotel is only a PLUS. To provide another example, user preferences module 232 can set the type of car to have a higher priority, by default, than which car rental company is used. Note that user preferences module 232 can store the travel preferences of more than one user. To search for a travel service for a particular user, that user's travel preferences are used to generate the search criteria. To search for a travel service for a group of users, user preferences module 232 retrieves travel preferences for each user in the group, and search criteria are generated based on the preferences of each user. Further, user preferences module 232 is capable of attaching different priorities to the preferences of different group members.

User preferences module 232 can store a user's travel preferences in one or more files that can be easily backed-up or transferred between personal computers. Note that a user's travel preferences can also include a user's personal information, for example the user's age, weight, residence address, sex, health needs and diet needs. A user's personal information can be used to plan or coordinate travel to meets a user's needs, such as obtaining a senior discount for a recreational activity, selecting a hotel with a pharmacy nearby, reserving a wheelchair at an airport, or arranging a vegetarian diet during a trip. Further, user preferences module 232 can control access to a user's travel preferences using a login ID and optional password to protect the privacy of a user's personal information and preferences. Other examples of user authentication techniques that can be used to protect a user's travel preferences include biometric techniques or a smart flash key. User preferences module 232 advantageously protects the privacy of a user's travel preferences by storing them locally at client 110, such as at the user's personal computer, thereby insulating the travel preferences from potential security risks of transmitting the data over a network or storing it remotely.

Client storage module 230 also includes search strategies module 250, which stores different search strategies that are used by the travel agent 220 to find travel services satisfying different search criteria. In one embodiment, search criteria are generated based on user travel preferences, examples of which are provided above with reference to user preferences module 232. To provide a few examples, search strategies can be tailored to various search criteria such as airport specifics, weather considerations, frequent flyer blackout dates, foreign travel visa requirements, ticket cancellation fees and availability of standby flights. Other examples of search criteria include whether the desired flight is domestic or international, for vacation or business travel, whether travel times are flexible, whether a user prefers mileage awards, and whether a user is willing to bid for a lowest cost using a bidding website.

As described above, each search strategy identifies one or more travel websites 130 that should be searched to efficiently find travel services satisfying a particular set of search criteria. Each search strategy also provides navigation information for efficiently searching each identified travel website 130, including information for accessing, navigating and parsing the travel website 130, and recognizing content in the travel website 130, entering data and search parameters into the travel website 130, and extracting data associated with a travel service from the travel website 130. Note that the strategy of which travel websites 130 to search, as well as the navigation information for each website 130, may vary significantly based on the search criteria. For example, the search strategy varies based on whether an airfare search is for domestic versus international travel. Further, a large number of user preferences can generate search criteria requiring a more complex search strategy. Further, the selected search strategy may also vary based on the priority of user preferences used to generate the search criteria.

Upon a user's request to search for travel services, travel agent 220 uses the search strategies to automatically and efficiently search for travel services satisfying a user's criteria. In one embodiment, the navigation information stored in search strategies module 250 enables to a travel agent 220 to simulate a user's navigation of a travel website 130. By simulating a user's navigation of a travel website 130, travel agent 220 is able to efficiently search a travel website 130 without being detected by the travel website 130, which continues to believe that it is being navigated by a human user. Therefore, travel agent 220 can efficiently perform the tedious task of searching a travel website 130 without being blocked by the travel website 130.

One embodiment of the present invention provides a travel agent 220 capable of searching multiple travel websites 130 having varied structural complexity and vocabulary. It is well known that website complexity continues to increase with the enhanced capabilities of web programming languages such as HTML, JavaScript, CGI and XML. The travel agent 220 understands the content, structure, vocabulary and programming of a travel website 130 based on the navigation information associated with the website 130. Navigation information associated with each travel website 130 includes information about the structure of various web pages in the website 130. Some types of structural information associated with a travel website 130 includes the location of input fields such as text boxes, check boxes or drop-down menus for inputting search criteria, the layout of search results retrieved by searching the travel website 130, how to parse the search results to obtain information about travel services, and how to activate links to web pages providing specific features of the travel website 130. Navigation information for a travel website 130 also identifies the vocabulary used by a travel website 130 to identify various types of information. Types of travel vocabulary include words, phrases and syntax. For example, one travel website 130 provides a check box entitled “Search one day before and after” to indicate flexible travel dates, while another travel website 130 provides the option of searching for flights “±1 to 3 days” of a desired date or on “flexible dates.” Other examples of vocabulary that identifies specific types of information are: “United” stands for the name of an airline, “flight+car” indicates the option of searching for an airline reservation as well as a car rental in a single search, “Mar” stands for the month of March, or that “Anytime” indicates no restricted travel time on a particular date. Travel agent 220 is capable of understanding a travel website's 130 vocabulary by referring to navigation information associated with the website 130. One skilled in the art will recognize that navigation information for a travel website 130 includes various other types of structural information and vocabulary that is useful to search the travel website 130.

Navigation information for a travel website 130 also includes information about which features are available in the travel website 130 and how travel agent 220 can efficiently employ these features while searching for a travel service. For example, a user can request the travel agent 220 to find a low cost airfare from Mountain View, Calif. to New York, departing on August 5 and returning on Aug. 10, 2005. The search criteria indicate that the user is willing to use any airport near these cities. A first travel website 130 provides the option of automatically including nearby airports to search for a low airfare, while a second website 130 does not provide this option. Navigation information for the first website 130 informs travel agent 220 of how to include nearby airports while searching the first website 130, while navigation information for the second website 130 informs travel agent 220 of how to repeatedly search the second travel website 130 for each pair of nearby departure and arrival airports in order to find a low fare meeting the user's search criteria. To provide another example, a user requests travel agent 220 to find the lowest cost airfare from Mountain View, Calif. to New York, departing approximately August 5 and returning approximately August 10. The search criteria indicate that the user is flexible with respect to departure dates and the length of stay. The first travel website 130 allows airfare search with flexible dates, but the second website 130 does not. Navigation information for the first website 130 informs travel agent 220 of how to search for flexible dates using the first website 130, while navigation information for the second website 130 informs travel agent 220 of how to repeatedly search the second travel website 130 for each pair of departure and arrival dates in order to find a low fare meeting the user's search criteria. As shown by the above examples, the search strategies include navigation information for searching travel websites 130 using various search criteria, such as a low cost airfare with flexible airports and/or flexible dates.

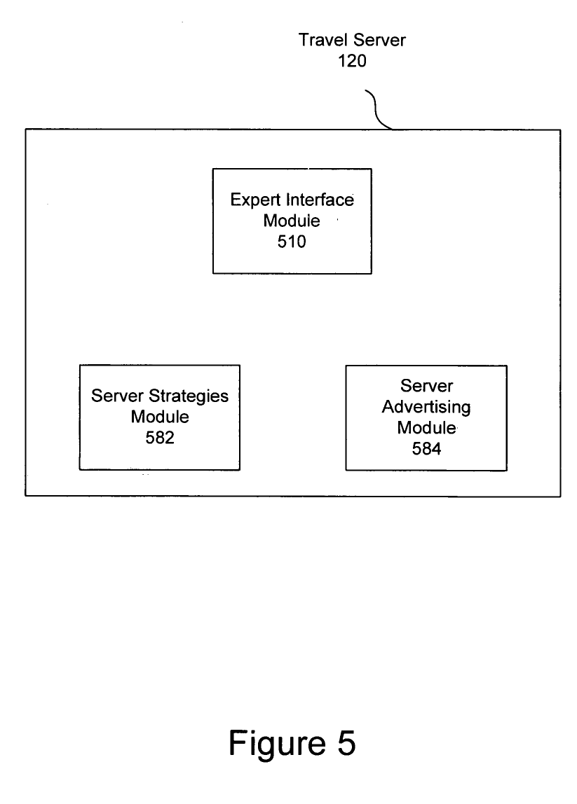

In one embodiment, search strategies module 250 receives search strategies from travel server 120 over network 150, the search strategies being created by travel website experts. FIG. 5 is a high-level block diagram showing a more detailed view of modules within travel server 120 according to one embodiment. Referring to FIG. 5, search strategies are created by experts using expert interface module 510, and travel server 120 stores the search strategies in server strategies module 582. Travel website experts know which travel websites 130 should be searched and how to search them for efficiently finding travel services satisfying a particular set of search criteria. They have in-depth knowledge of how to efficiently search each travel website 130 for a travel service satisfying specified search criteria. Experts also understand how to utilize the various features of a travel website 130, how and where to input search parameters, and how to extract relevant results. Travel website experts use their know-how to create the search strategies that allow a travel agent 220 to automatically search multiple travel websites 130. By creating search strategies that are downloaded to multiple clients, travel website experts are able to share their knowledge with travel agents 220 residing on these clients. Users with limited knowledge of travel websites 130 can request a travel agent 220 to automatically and efficiently search for travel services by using the search strategies created by experts. Note that search strategies being downloaded from travel server 120 to client 110 can be encrypted to secure the data transfer, and can be compressed to reduce bandwidth usage and to increase the speed of the download process.

Travel websites 130 are often changed to improve their services, and new travel websites 130 sometimes become available providing unique features or catering to a particular market. Example improvements to a travel website 130 include adding new features such as the ability to search for last minute deals, adding more input fields so that a user can tailor a search to his specific needs, or improving the format for data entry and presentation. Travel website experts routinely monitor travel websites 130 for changes, search for new travel websites 130, and update the search strategies stored at travel server 120 to reflect any changes. More particularly, travel website experts update the navigation information associated with a travel website 130 in response to changes in the website 130. Search strategies can also be updated by experts to reflect changing market conditions. By downloading the updated search strategies to client 110, a travel agent 220 resident at client 110 is aware of changes to a travel website 130 when it searches for a travel service. In one embodiment, travel agent 220 requests search strategy updates from travel server 120 automatically. For example, travel agent 220 may request search strategy updates from travel server 120 on a periodic basis, or alternatively, prior to performing a search for travel services. In another embodiment, travel server 120 can initiate downloads of search strategies to client 110.

Note that updated search strategies may need to be downloaded to millions of clients, consuming significant time and resources even if multiple travel servers 120 are employed. In one embodiment, the task of downloading search strategies from travel server 120 to client 110 is streamlined by storing the search strategies in discrete elements that are amenable to incremental updates based on changes to a travel website 130. For example, navigation information used to search a particular travel website 130 for a particular set of search criteria is stored as a discrete element in server strategies module 582; when this navigation information changes, the discrete element storing this navigation information is selectively downloaded to server strategies module 582 in client 110. To provide another example, when a new airline website for domestic travel becomes available, travel website experts create new navigation information for searching the new website. To incorporate the new navigation information, client 110 only downloads search strategies that need to be updated with the new navigation information. Alternatively, to further increase efficiency of updating search strategies in client 110, only changes to the discrete elements need to be downloaded. In yet another embodiment, it may be preferable for client 110 to download all search strategies whenever there is an update, thereby avoiding the need to modularize the search strategies into discrete elements.

One embodiment of the present invention selectively downloads updated search strategies based on usage characteristics of a particular travel agent 220, such as frequency of usage or the preferred travel websites 130 of a user, or based on characteristics of a particular travel website 130, such as how often the website 130 is updated. For example, search strategies module 250 at a client 110 is updated if the travel agent 220 at the client 110 searches for travel services with at least a certain frequency. To enable such selective downloads, each travel agent 220 informs the travel server 120 each time it is used. The travel server 120 keeps a list of travel agents 220 ranked by their frequency of usage or by how recently each travel agent 220 was used to search for travel services. For example, a travel agent 220 that has not been used in six months can be classified as lower priority and updated on a less immediate basis. To provide another example, a travel agent 220 that has not been used for at least one year can be classified as inactive. Updated search strategies can be downloaded to inactive travel agents 220 when a user requests the travel agent 220 to search for travel services.

Information associated with travel services can be cached so that travel agent 220 can efficiently retrieve the information without searching multiple travel websites 130. In one embodiment, search strategies module 250 retrieves information associated with travel services from multiple travel websites 130 and stores the information in a database to enable efficient access by travel agent 220. In another embodiment, travel server 120 retrieves and stores information associated with travel services in server strategies module 582, from where it can be periodically downloaded to client 110. An exemplary database storing information about travel services is illustrated by lodging data module 260. Lodging data module 260 stores comprehensive lodging information, including the price and availability of lodgings as well as travel services associated with lodgings at multiple travel destinations. Note that lodging information can also include advertisements for lodgings and associated travel services. Lodgings include any type of accommodation, for example hotels, motels, inns, timeshares for rent, and short-term or long-term home rentals. Examples of travel services associated with a lodging include amenities such as a swimming pool or casino at the lodging, or restaurants and recreational facilities near the lodging. By caching lodging information, travel agent 220 can efficiently search lodging data module 260 for lodging reservations and associated travel services that meets desired search criteria, without the need for searching multiple travel websites 130 for the lodging information. Further, once a user indicates interest in particular lodging information that was previously cached, travel agent 220 can search a travel website 130 to confirm accuracy of the information or to search for additional information relevant to the user's interest.

In one embodiment, lodging data module 260 stores lodging information associated with travel destinations at which travel services have been requested by a user recently. For example, lodging data module 260 stores lodging information retrieved by a travel agent 220 during a recent lodging search. Time sensitive lodging information, e.g. the price of a hotel room, can be discarded from lodging data module 260 after a certain time frame. Other types of lodging information that remains constant over time, e.g. hotel ratings or amenities, can be retained by lodging data module 260 for a longer amount of time.

Referring to FIG. 5, lodging information in server strategies module 582 can be maintained and updated by lodging experts via expert interface module 510. In one embodiment, lodging information can be periodically downloaded to lodging data module 260. In another embodiment, travel agent 220 can query server strategies module 582 to download lodging information that meets a user's preferences such as a travel destination. In yet another embodiment, lodging information associated with a user's preferred travel destinations is automatically downloaded from server strategies module 582 on a regular basis.

Client storage module 230 includes search data module 240 for storing information associated with searches performed by the travel agent 220, including search parameter module 242 as well as search results module 244. To search a travel website 130 for travel services, search travel agent 220 generates search parameters for the travel website 130 based on the search criteria and the format for inputting various types of information in the travel website 130. In one embodiment, the search parameters used to search a particular travel website 130 based on particular search criteria are stored in search parameter module 242. For example, a particular travel website 130 may require a departure date to be entered in the format “mm/dd/yyyy”. For searching the particular travel website 130, travel agent 220 generates the search parameter “08/20/2005” based on the search criteria, and can store the search parameter in search parameter module 242. Other examples of search parameters in a travel website 130 include the location of a hyperlink or check box to be selected or the selection of an item in a dropdown menu. Search parameters stored in search parameter module 242 can be retrieved to repeat a search request that is based on the same search criteria or to generate new search parameters based on modified search criteria. In one embodiment, search results module 244 stores the results of a search, such as relevant information about travel services that satisfy the search criteria. Some benefits of storing search results in search results module 244 is that they can be displayed to a user, used to generate a travel itinerary, or used to compare search results from different websites 130 or from different time periods.

In one embodiment, client storage module 230 includes travel logistics module 236 that stores various travel logistics used to plan efficient travel arrangements that meet a user's preferences. Example travel logistics include airports near a particular location, hotels near an airport, the travel time between a hotel and a user's destination, a number of connections or stopovers for a flight, presence of an airport to hotel shuttle, airports to avoid during certain seasons, availability of backup flights and the cost of changing flights, and the time needed to pick up a rental car. Travel logistics may be used to generate search criteria that are used to search for travel services. Travel logistics may also be used to analyze search results retrieved from travel websites 130. For example, travel logistics may be used to generate a travel plan that combines a flight reservation to a particular airport with a hotel or car rental near that airport. To provide another example, travel logistics may be used to filter search results that will reduce the efficiency of travel, such as airline travel schedules having large number of connections.

Client storage module 230 further includes an advertising data module 234 for storing advertising data for the travel agent 220. In one embodiment, travel agent 220 searches the advertising data for advertisements satisfying a user's preferences and/or associated with travel services selected by the user. Travel agent 220 can present the retrieved advertisements to a user. Note that travel agent 220 is able to find advertisements specifically targeted to a user's needs because it has extensive knowledge of a user's preferences stored in user preferences module 232. Advertising data includes advertisements associated with various user preferences and with various travel services that may be selected by a user. Some advertisements may be associated with a particular location being visited by a user, such as the location of a travel service reserved by the user. For example, advertisements associated with an airline reservation may advertise a car rental, hotel or recreation activity at a destination airport for the reservation. To provide another example, advertisements associated with a hotel reservation include information about a car rental, restaurant or recreational activity near the hotel. Yet another example is a timely discounted spa package in or near a destination hotel, offered to a user who enjoys spa treatments. One type of advertisement is a discount coupon that is valid during a user's travel dates, another type of advertisement may include a link to a particular website providing information about a travel service, while other types of advertisements will be apparent to one having ordinary skill in the art.

Referring to FIG. 5, travel server 120 stores advertising data in server advertising module 584. In one embodiment, advertising data module 234 receives advertising data from travel server 120 over network 150. In an alternate embodiment, travel agent 220 requests server advertising module 584 to search for relevant advertisements.

In one embodiment, advertising data associated with various travel services is created by travel website experts via expert interface module 510. Alternatively, advertising data can be retrieved from databases or websites of advertising firms or companies. In another embodiment, advertising data is created by companies who pay to have their products or services advertised by travel agent 220.

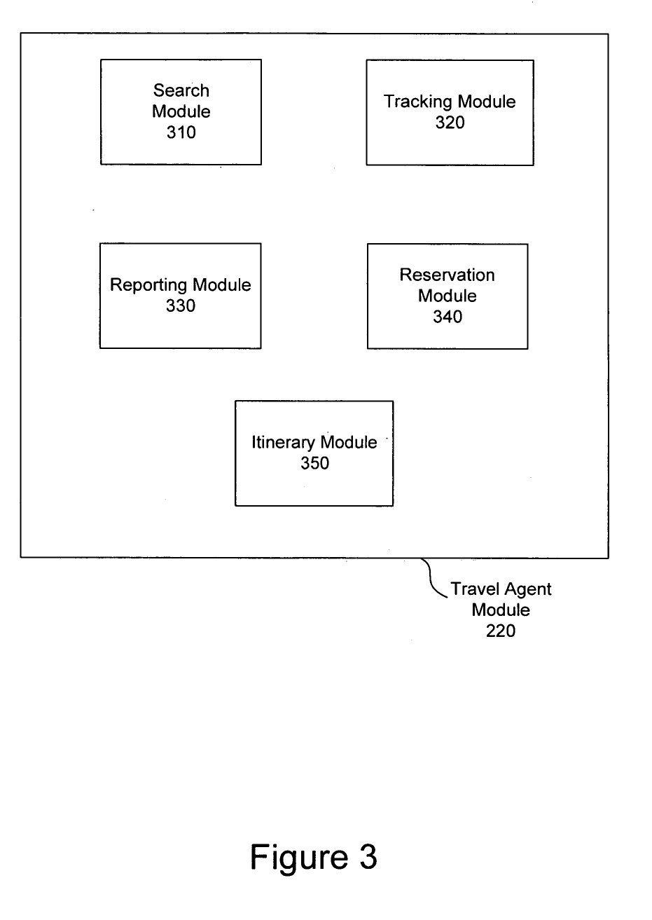

FIG. 3 is a high-level block diagram illustrating a more detailed view of travel agent 220 according to one embodiment. Travel agent 220 comprises a search module 310, a tracking module 320, a reporting module 330, a reservation module 340 and an itinerary module 350.

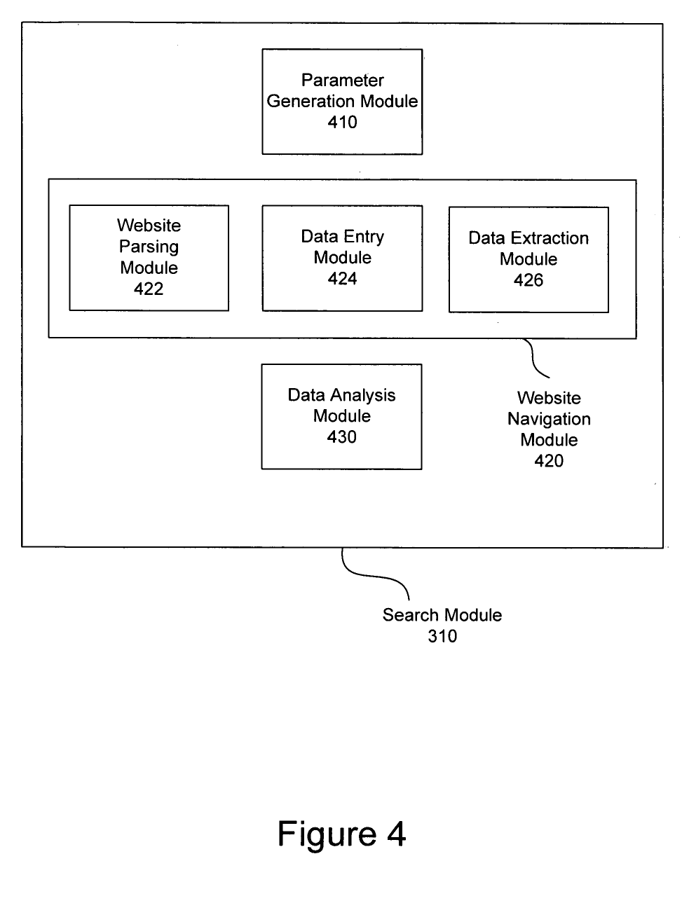

Search module 310 performs various functions of travel agent 220, such as generating search criteria based on a user's preferences, selecting a search strategy for finding travel services satisfying the search criteria, and implementing the search strategy to automatically search one or more travel websites 130 for desired travel services. FIG. 4 is a high-level block diagram illustrating a more detailed view of search module 310 according to one embodiment. Search module 310 comprises parameter generation module 410, website navigation module 420, and data analysis module 430.

To enable search module 310 to automatically search a particular travel website 130, parameter generation module 410 generates search parameters for searching the travel website 130 based on search criteria associated with the request. Each search parameter is tailored to a specific input format required for populating an input field in the travel website 130. As explained above, in one embodiment the search parameters used to search a particular travel website 130 based on particular search criteria are stored in search parameter module 242. Example search parameters for an airline reservation are a departure date and a checkbox indicating that an aisle seat is desired.

Website navigation module 420 accesses, navigates and searches a travel website 130 to find travel services satisfying the search criteria. To perform these functions, website navigation module 420 uses navigation information for each website. As explained above with reference to search strategies module 250, navigation information created by experts for each website provides information needed to navigate and parse the website, to recognize web page content, and to enter or extract data. Navigation information created by experts includes information about the structure of each website, the location of relevant fields, the format of data in the website and the vocabulary associated with different types of information. Note that website navigation module 420 is capable of emulating a user's access, navigation and search of a travel website 130 in a manner that is transparent to the travel website 130, thereby allowing travel agent 220 to automatically search the travel website 130 without being blocked by the travel website 130. For example, website navigation module 420 is capable of emulating a user's keyboard, mouse, or touch pad inputs in a travel website 130.

In one embodiment, website navigation module 420 comprises website parsing module 422, data entry module 424 and data extraction module 426. Website parsing module 422 parses a travel website 130 to identify various fields of the website 130, such as input fields, hyperlinks, and fields providing information about search results. To perform a search for travel services, data entry module 424 enters search parameters for a travel website 130 into the appropriate input fields in the website 130, and initiates a search on the travel website 130. For example, a search is initiated on an exemplary travel website 130 by emulating a user's click on the “Perform Search” button. Upon completion of the search, data extraction module 426 navigates the search results, which may be spread over multiple web pages and which may be presented in different formats for different travel websites 130. Data extraction module 426, in conjunction with website parsing module 422, also parses the search results to identify and extract relevant information for travel services satisfying the search criteria. Examples of relevant information for a travel service include the airline company, number of connecting flights, total travel time, schedule and price for an airfare reservation. Note that data extraction module 426 is capable of extracting relevant information from a variety of travel websites 130, including specialty travel websites such as TRAVELZOO that provide listings of travel services under specific categories. For example, data extraction module 426 can navigate TRAVELZOO to extract relevant information from a listing of vacation packages to Hawaii by navigating to a hyperlink for this listing. Information extracted from travel websites 130 can be stored in search results module 244 before it is presented to a user.

Once search module 310 has searched one or more travel websites 130, data analysis module 430 analyzes the extracted information to identify travel services particularly suited to a user's preferences. Travel websites 130 typically facilitate searching for travel services based on only a limited number of search parameters. Data analysis module 430 can refine the search results by filtering the extracted information to find travel services particularly suited to a user. Data analysis module 430 can filter the extracted search results based on a wide range of user preferences stored in user preferences module 232. For example, if a user indicates that he is not interested in flights with connections or stopovers, data analysis module 430 can screen out those flights for the user. To provide another example, if a user requires lodgings with at least a 3 star rating, data analysis module 430 can screen out lower rated lodgings before search results are presented to a user. Other types of data analysis includes comparing the various travel services retrieved from a search or sorting the retrieved travel services based on a priority of user preferences. For example, if a user indicates that his most important criteria for a flight reservation is the arrival time, data analysis module 430 can sort the retrieved flights based on their arrival time or can eliminate flights that arrive too late.

As explained above, search module 310 implements a search strategy to automatically search one or more travel websites 130 for travel services that satisfy a particular set of search criteria. Tracking module 320 tracks current information associated with one or more of the travel services returned by a search. Examples of current information tracked include price, availability, schedule, weather forecast, or estimated delays associated with travel services. In one embodiment, current information can be tracked based on search criteria, such as tracking the lowest price for any airline reservation that that meets the user's schedule. Alternatively, the current information is tracked for a particular travel service, such as tracking the current price for a cruise to Alaska departing from San Francisco on Nov. 4, 2005.

In one embodiment, a user can specify each travel service for which information should be tracked. For example, when the results of a search are displayed to a user, the user can select those travel services for which they wish to receive updates. In another embodiment, tracking module 320 can track the current information associated with a subset of the search results, for example the 20 travel services that most closely match the user's preferences. The group of search results being tracked may be referred to as a watch list of travel services.

In one embodiment, tracking module 320 periodically implements a search strategy to track current information associated with a travel service, wherein the search strategy identifies one or more travel websites 130 and information for navigating each identified website to find the current information associated with the travel service. During each periodic implementation of the search strategy, tracking module 320 uses the navigation information to search the one or more travel websites 130 for the travel service, and retrieves current information associated with the travel service from a travel website 130. Note that periodic implementation of the search strategy may be performed at irregular intervals of time, which may be specified by a user. For example, a user can instruct travel agent 220 to search for vacation packages at a particular destination or in a particular price range. Alternatively, periodically implementing the search strategy may comprise repeatedly implementing the search strategy whenever tracking module 320 determines that the current information for the travel service is likely to have changed. For example, tracking module 320 can search for current information associated with a resort reservation in Hawaii whenever the weather forecast for Hawaii changes.

Tracking module 320 is capable of implementing a search strategy to perform a full search or a partial search. During a full search, each travel website 130 identified by a search strategy is exhaustively searched for travel services satisfying the search criteria. During a full search, several travel websites 130 may be searched and many different results may be returned. The results of a full search may be sorted based on the priority of a user's preferences, such as cost, following which they are displayed to a user by reporting module 330, as explained in further detail below. Tracking module 320 is also capable of performing partial searches to search a subset of the travel websites 130 identified by a search strategy, or to track the watch list of travel services. As explained above, tracking module 320 can perform partial searches to track current information for a subset of travel services returned by a full search. Partial searching allows tracking module 320 to efficiently retrieve relevant information by reducing the time and cost that would be required for a full search.

In one embodiment, tracking module 320 periodically implements a search strategy in the background to track current information for travel services in the watch list. Automatic repetition of searches by tracking module 320 allows a user to get a good deal on travel services whose rates vary over time, such as time-dependent airfares and hotel room rates. When the information associated with a travel service changes, tracking module 320 provides a user indication that current information for a travel service has changed. For example, tracking module 320 provides a screen popup or notification icon to alert a user that the best price for airline reservations in the watch list has changed. Tracking module 320 can also provide users with a status report describing the historical change in information associated with a travel service over various implementations of the search strategy. For example, the status report shows the change in price of an airline reservation or the change in the availability of seats on a flight over time.

In one embodiment, the current information for a travel service is presented to a user when it satisfies a notification criterion. Notification criteria can be specified by a user. Alternatively, tracking module 320 determines notification criteria based on a user's preferences. An example of a notification criterion is a maximum price (e.g. $200) for an airline reservation, where a user is notified when the airfare falls below the maximum price. Another example of a notification criterion is availability of lodging and a user can be notified, for example by a popup alert, an icon, or email, when lodging becomes available. Other examples of notification criteria include cancellation of a flight, an unfavorable weather forecast at the user's travel destination, or a change in dates for a vacation package.

By repeatedly implementing a search strategy to track the current information associated with a travel service, tracking module 320 is capable of tracking trends in the current information over time. To track trends, tracking module 320 stores the current information from one or more repetitions of the search strategy. As explained above, results of a search are stored in search results module 244. Changes in a particular type of information, such as price or availability, can then be summarized over time for a user. In one embodiment, tracking module 320 periodically implements the search strategy to track the current price associated with an airline reservation, stores the current price from one or more implementations of the search strategy, and generates a price trend indicator based on the current price stored during various implementations of the search strategy. The price trend indicator can be presented to a user to help the user decide when to purchase the travel service. For example, a user interested in traveling from Chicago to San Francisco in March may decide to delay the purchase of an airline ticket if the price trend indicator shows that Chicago to San Francisco airfares for March have been declining.

To facilitate repeated implementation of a search strategy, tracking module 320 can cache the search parameters used to search a particular travel website 130 based on particular search criteria. As explained above, search parameters can be stored in search parameter module 242. In addition to search parameters, tracking module 320 can also cache other types of information to facilitate repeated implementation of a search strategy, such as a list of websites identified by the search strategy and the steps performed to emulate user input for searching each identified website. By retrieving the cached website list, search parameters and user emulation steps prior to each implementation of a search strategy, tracking module 320 eliminates the need for regenerating the search parameters and user emulation steps each time a travel website 130 is searched, thereby increasing the speed of repeated implementations and reducing processing requirements.

In one embodiment, reporting module 330 presents the results of a search to a user, wherein the search results include information associated with travel services satisfying the search criteria. Some examples of information associated with a travel service include an itinerary for travel services reserved by the user, a map for the city at which a hotel is located, driving directions from a destination airport to a hotel, an advertisement for a recreational activity such as white water rafting near a vacation resort, or discount lunch coupons associated with a sightseeing tour. Note that travel services retrieved by implementing a search strategy can be presented to a user in various formats. One such format is a linear listing of travel services satisfying the search criteria. Another such format is a matrix that facilitates comparison of relevant information, such as prices and schedules, across search results.

Reservation module 340 allows a user to reserve a travel service found by search module 310. Note that reserving a travel service includes booking or purchasing the service. To reserve a travel service according to one embodiment, reservation module 340 directs a user to the travel website 130 from which the travel service was retrieved. Reservation module 340 can perform parameter generation, website parsing and data entry to automatically direct a user to the reservation step of a travel website 130. In an alternate embodiment, reservation module 340 can reserve a travel service for the user, optionally requesting the user for final confirmation before completing the reservation. For example, reservation module 340 awaits a user's final confirmation before submitting the user's credit card information to complete a purchase. The travel service to be reserved can be selected by a user, or alternatively reservation module 340 can reserve the travel service that most closely meets the user's preferences.

Itinerary module 350 provides users with an itinerary for one or more travel services that have been reserved, selected by a user or retrieved from a search. As explained above, travel agent 220 implements a search strategy to search multiple travel websites 130 for travel services satisfying certain search criteria and facilitates reservation of various types of travel services. For example, a user can request a travel agent 220 to search for an airline reservation to London, a three-star hotel in London, recreational activities such as museums and dance clubs near the hotel, and a trip to the British countryside. In one embodiment, communication module 210 receives an indication of travel services selected by a user, wherein the travel services can be associated with different travel websites 130. For example, the user selects an airline reservation through Travelocity.com and a hotel room through ORBITZ. Next, search module 310 retrieves information associated with the selected travel services from the travel websites 130, and itinerary module 350 generates a unified itinerary for the travel services by combining the retrieved information. The unified itinerary includes information such as air tickets, hotel reservation information, car rental information, driving directions, restaurants near the reserved hotel, points of interest in the destination city, and available mileage or hotel awards. For example, the unified itinerary to London includes directions from the user's home to the departure airport; the flight number and schedule for the flight to London; instructions for various alternative means of transportation from the London airport to the reserved hotel; and directions for the trip to the countryside. Note that travel agent 220 is able to compile a unified travel itinerary for a user because it resides on the user's personal computer and has information about various travel services reserved by the user. A user can review the unified itinerary on a screen and print the unified itinerary for convenient reference during his or her trip.

Itinerary module 350 can also retrieve additional information relevant to travel services through the internet. In one embodiment, itinerary module 350 retrieves maps and driving directions associated with a travel service from map websites such as Yahoo! Maps or Google Maps by automatically navigating the map websites and entering necessary data such as the departure and destination addresses. In another embodiment, travel agent 220 retrieves advertisements associated with a travel service from advertising data module 234. Maps, driving directions, and advertisements can be presented to a user integrated with, or in addition to, the unified itinerary. For example, the unified itinerary to London is presented in conjunction with maps of London as well as advertisements of recreational activities such as visiting Big Ben or a dance club.

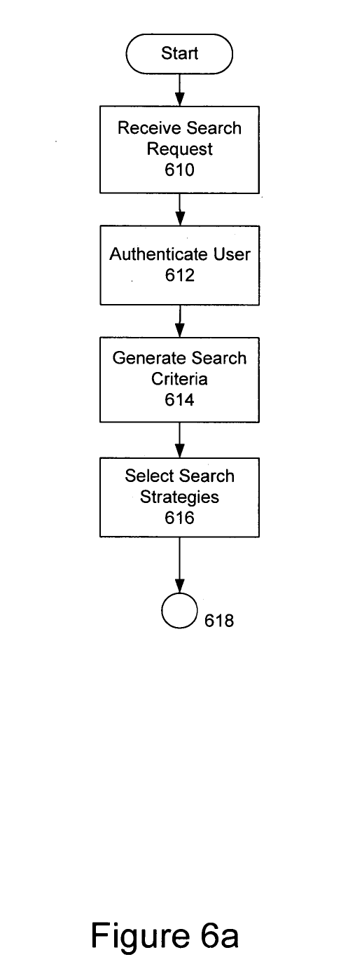

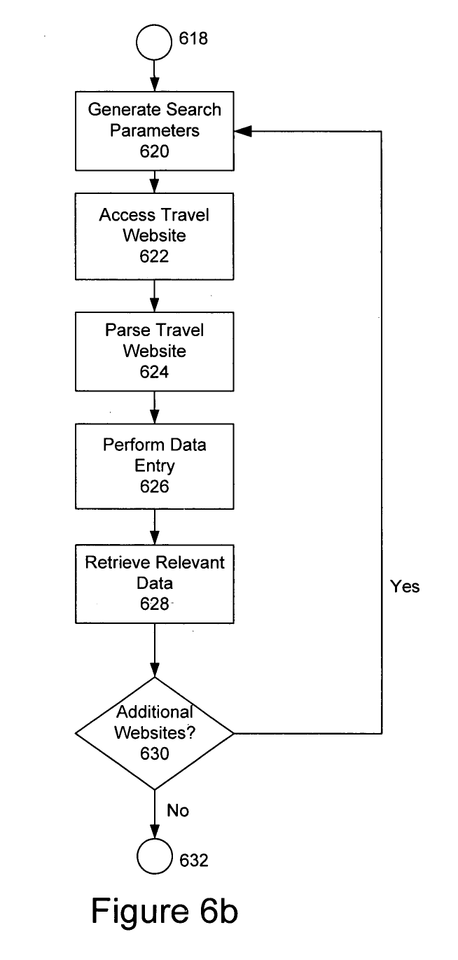

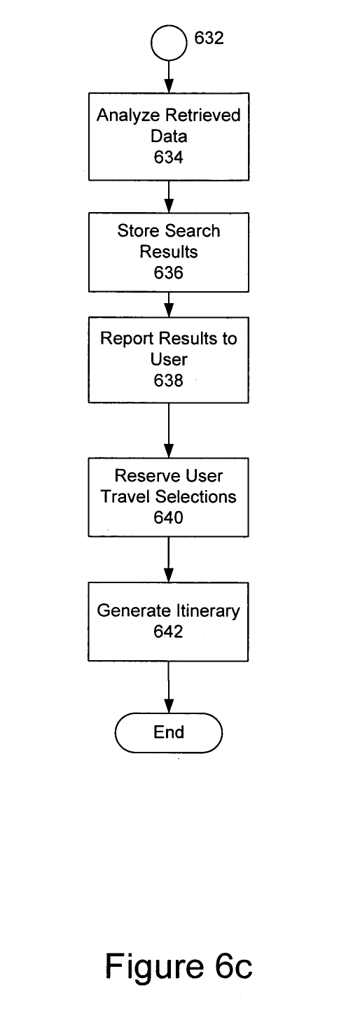

FIG. 6 is a flow chart illustrating steps performed by travel agent 220 to search for travel services according to one embodiment. Those skilled in the art will recognize that different embodiments can perform other and/or additional steps than the ones shown in FIG. 6. Moreover, other embodiments can perform the steps in different orders than the one shown. Further, although the steps in FIG. 6 are performed by travel agent 220, one skilled in the art will recognize that these steps can also be performed by another module implemented in hardware, firmware or software or by a combination of other modules.

Travel agent 220 receives 610 a request to search for travel services. A search request from a user can be received 610 at client 110. As explained above, a search request can be received 610 from remote client interface 140, such as a cell phone or personal digital assistant. Upon receiving 610 the request, travel agent 220 can optionally authenticate 612 the user by requesting a login and password. In one embodiment, the entered login and password can be verified by referring to a database of authentication data stored at client 110. By authenticating 612 a user who requests a search for travel services, travel agent 220 can verify the user is a legitimate user. Further, authenticating 612 a user also allows travel agent 220 to identify the user's travel preferences in user preferences module 232.

Travel agent 220 generates 614 search criteria associated with the request based on a user's travel preferences. To plan efficient travel arrangements that meet a user's preferences, travel logistics can also be used to generate the search criteria. Upon generating 614 search criteria, travel agent 220 selects 616 a search strategy for finding travel services satisfying the search criteria. The search strategy can be selected 616 from a plurality of search strategies stored at client 110 based on the search criteria associated with the request. Each search strategy identifies one or more travel websites 130 as well as information for travel agent 220 to efficiently navigate the websites.

FIG. 6b illustrates steps performed by travel agent 220 to implement the search strategy for searching each travel website 130 to find travel services satisfying the search criteria. Step 618 represents a connector between steps 616 and 620. To search each travel website 130 for travel services, travel agent 220 generates 620 search parameters for the travel website 130 based on the search criteria and the format for inputting various types of information in the travel website 130. By using navigation data created by experts, travel agent 220 is capable of automatically emulating user navigation of a travel website 130, including accessing 622 and parsing 624 the travel website 130, performing 626 data entry, initiating a search on the website 130, and retrieving 628 relevant data. Parsing 624 a travel website 130 uses conventional techniques such as regular expression matching to identify various fields of the website 130 and the location of different types of information in the website 130. Travel agent 220 performs 626 data entry to enter search parameters for a travel website 130 into the appropriate fields, and initiates a search of the travel website 130. Upon completion of the search, travel agent 220 navigates and parses the search results to retrieve 628 relevant data for travel services satisfying the search criteria. Relevant search results retrieved from the travel website 130 can be stored in search results module 244. Upon completing a search of a travel website 130, travel agent 220 checks 630 whether the search strategy specifies that additional travel websites 130 should be searched. If additional websites are specified, travel agent 220 repeats steps 620 through 628 to navigate each additional travel website 130 for finding travel services satisfying the search criteria. Step 632 represents a connector between steps 630 and 634.

At the selected search strategy has been implemented to search each identified travel website 130, travel agent 220 analyzes 634 retrieved data for travel services satisfying the search criteria. Data analysis 634 can refine the search results by filtering the retrieved data to identify travel services particularly suited to a user. Travel agent 220 is also capable of other types of data analysis 634, such as comparing various travel services retrieved from a search or sorting the retrieved travel services based on a priority of user preferences. As explained above with reference to travel logistics module 236, travel agent 220 can further refine search results based on travel logistics that are used to plan efficient travel arrangements.

Travel agent 220 stores 636 the refined search results, which include relevant information associated with travel services satisfying the search criteria, at client 110. If a search strategy is repeatedly implemented to track current information associated with available travel services, travel agent 220 can store the change in current information between successive implementations of the search strategy. Once search results have been analyzed 634 and stored 636, travel agent 220 reports 638 the results to a user in linear or matrix form.

Travel agent 220 is also capable of reserving 640 a travel service selected by a user by directing the user to the reservation page of the website where the travel service was found. Alternatively, travel agent 220 can automatically reserve the travel service that most closely matches the user's travel preferences. When one or more travel services have been reserved 640 for a particular trip, travel agent 220 can automatically navigate the travel websites 130 on which the reservations were made to retrieve information associated with each of the reserved services. Further, travel agent 220 can generate 642 a unified itinerary for the trip by combining the retrieved information for the reserved travel services.

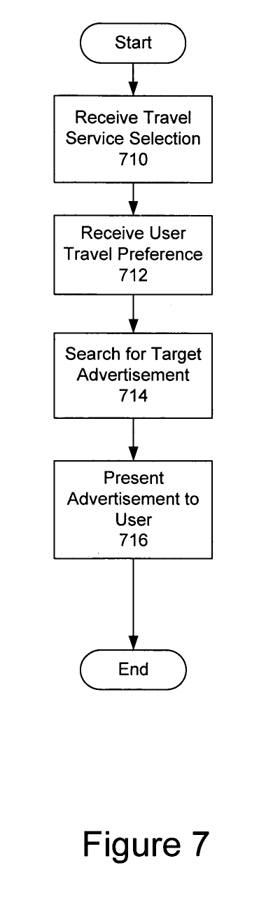

FIG. 7 is a flow chart illustrating steps performed by travel agent 220 to provide target advertising according to one embodiment. Those skilled in the art will recognize that different embodiments can perform other and/or additional steps than the ones shown in FIG. 7. Moreover, other embodiments can perform the steps in different orders than the order shown. Further, although the steps in FIG. 7 are performed by travel agent 220, one skilled in the art will recognize that these steps can also be performed by another module implemented in hardware, firmware or software or by a combination of other modules.

To provide target advertising according to one embodiment, travel agent 220 receives 710 an indication of a travel service selected by a user. A user can indicate selection of a travel service in a variety of ways, such as clicking on a link to retrieve additional information about the travel service or by reserving the travel service. Travel agent 220 also receives 712 an indication of the user's travel preferences. In one embodiment, receiving 712 an indication of the user's travel preferences comprises querying the user for his travel preferences. In another embodiment, travel agent 220 can retrieve the user's preferences from user preferences module 232. In a further embodiment, travel agent 220 can determine a user's personal preference based on a travel service selected by a user. For example, a user's selection of a non-smoking hotel room on a previous trip to Hawaii indicates that the user prefers non-smoking accommodations. In yet another embodiment, an advertisement selected by a user can provide an indication of the user's travel preferences. For example, a user's click on an advertisement for scuba diving indicates that the user enjoys scuba diving.

Travel agent 220 searches 714 for target advertisements associated with a travel service selected by a user and/or the user's travel preferences. Examples of target advertisements associated with an airline reservation include a car rental or hotel at an airport associated with the airline reservation, or a recreational activity at the destination of the flight. Examples of target advertisements associated with a hotel room reservation at a particular location include a car rental, restaurant or recreational activity near the hotel's location. Travel agent 220 can find advertisements for various travel services such as entertainment, sporting events, restaurants, lodging, and spa treatments. Target advertisements can be based on the location of a user's travel. For example, when a user who prefers French cuisine books a flight to Chicago, travel agent 220 can search 714 for French restaurants in Chicago. Target advertisements can also be time-sensitive or valid for a particular duration of time. For example, when an avid golfer flies to Phoenix, Ariz., travel agent 220 can search for discount coupons to golf courses in Phoenix that are valid during the user's stay in Phoenix. Yet another example of target advertisements is presenting a user with a list of restaurants that offer discounts based on a credit card, such as Diner's Club, held by the user. In one embodiment, travel agent 220 searches 714 for target advertisements using the advertising data stored in advertising data module 234 at client 110. In another embodiment, travel agent 220 can query server advertising module 284 at travel server 120 for target advertisements associated with a selected travel service or with a user's preferences. In a further embodiment, travel agent 220 can query an advertising server for advertisements relevant to a user's preferences or travel services selected by the user. Based on extensive knowledge of a user's travel preferences, travel agent 220 is able to present a user with target advertisements that are particularly useful to plan the user's travel arrangements. Further, target advertisements allow advertisers to directly reach customers who are likely to be interested in their travel services.

Travel agent 220 presents 716 retrieved advertisements to a user. In one embodiment, retrieved advertisements are displayed to a user, who can get more detailed information by selecting the advertisement. In another embodiment, target advertisements can be printed or displayed to a user in conjunction with a travel itinerary or details of a reservation.

Travel agent 220 can charge advertising fees to a vendor for presenting 716 target advertisements to a user. In one embodiment, travel agent 220 charges an advertisement fee based on a number of times the advertisement is displayed or printed for a user whose preferences meet an advertiser's criteria. Note that the advertiser's criteria can be specified by the advertiser, or travel agent 220 can automatically select the advertiser's criteria based on the content or subject of the advertisement. For example, travel agent 220 charges an advertisement fee to an ice cream vendor in Las Vegas each time a user prints a discount coupon provided by the vendor.

The above description is intended to illustrate the operation of the preferred embodiments and is not meant to limit the scope of the invention. From the above discussion, many variations will be apparent to one skilled in the relevant art that would yet be encompassed by the spirit and scope of the invention. Although the above description is directed to an intelligent travel agent 220 that automatically searches for travel services, one skilled in the art will recognize that the above-described techniques can readily be applied to an automated search agent that automatically searches websites for various types of products or services that may or may not be related to travel.

1. A computer implemented method of searching for a travel service, comprising:
receiving a request to search for the travel service at a user's personal computer, wherein the request is associated with a search criterion;
selecting a search strategy from a plurality of search strategies responsive to the request, wherein the search strategy identifies a travel website and navigation information associated with the travel website; and
implementing the search strategy to search the travel website for the travel service satisfying the search criterion using the navigation information, wherein searching the travel website is performed by the user's personal computer.

2. The method of claim 1, wherein the search strategy is selected from the plurality of search strategies based on the search criterion.

3. The method of claim 1, wherein the search criterion is generated based on a plurality of user preferences stored locally at the user's personal computer.

4. The method of claim 1, wherein the search strategy is selected from the plurality of search strategies based on a plurality of user preferences.

5. The method of claim 4, wherein the plurality of user preferences are ranked according to a priority that is used to select the search strategy.

6. The method of claim 1, wherein the travel service consist of at least one of:
an airline reservation;
a hotel room;
a rental car;
a cruise; and
a vacation package.

7. The method of claim 1, wherein the search criterion consists of at least one of:
a schedule for the travel service;
a location for the travel service; and
a price range for the travel service.

8. The method of claim 1, wherein the navigation information associated with the travel website consists of at least one of:
information associated with accessing the travel website;
a vocabulary associated with the travel website;
information associated with parsing the travel website;
information associated with data entry in the travel website; and
information associated with data extraction from the travel website.

9. The method of claim 1, wherein implementing the search strategy to search the travel website for the travel service satisfying the search criterion comprises:
accessing a webpage associated with the travel website; and
parsing the travel website to identify a field, wherein the field consists of at least one of:
a link to a webpage associated with the travel service;
an input field for inputting a search parameter; and
a field including information associated with the travel service.

10. The method of claim 9, wherein implementing the search strategy further comprises entering the search parameter in the input field, wherein entering the search parameter in the input field is performed by the user's personal computer.

11. The method of claim 9, wherein implementing the search strategy further comprises extracting the information associated with the travel service, wherein extracting the information associated with the travel service is performed by the user's personal computer.

12. The method of claim 1, wherein the plurality of search strategies are created by a travel website expert.

13. The method of claim 1, wherein implementing the search strategy to search the travel website for the travel service satisfying the search criterion comprises emulating a human user's interaction with the travel website.

14. The method of claim 13, wherein emulating the human user's interaction with the travel website consists of emulating at least one of the human user's keyboard input and the human user's mouse input.

15. The method of claim 1, further comprising presenting the user with information associated with the travel service.

16. The method of claim 15, wherein the information associated with the travel service consists of at least one of:
an itinerary for the travel service;
a map associated with the travel service;
driving directions associated with the travel service;
an advertisement associated with the travel service; and
a discount coupon associated with the travel service.

17. The method of claim 15, further comprising:
receiving an indication of the user's selection of the travel service; and
directing the user to a website for reserving the travel service.

18. The method of claim 1, wherein searching the travel website comprises emulating a human user's interaction with the travel website.

19. The method of claim 1, wherein the plurality of search strategies are downloaded from a travel server and wherein the plurality of search strategies are stored locally at the user's personal computer.

20. The method of claim 1, wherein the search strategy varies based on the search criterion indicating at least one of:
domestic or international travel;
fixed or flexible travel dates;
fixed or nearby airports;
flight, hotel, or car; and
deal, cruise, or vacation.

21. A computer implemented method of searching for a travel service, comprising:
receiving a request to search for the travel service at a user's personal computer, wherein the request is associated with a search criterion;
selecting a search strategy from a plurality of search strategies responsive to the request, wherein the search strategy identifies a travel website and navigation information associated with the travel website and wherein the search strategy is created by a travel website expert; and
implementing the search strategy to search the travel website for the travel service satisfying the search criterion using the navigation information, wherein searching the travel website is performed by the user's personal computer.

22. The method of claim 21, wherein the plurality of search strategies are stored locally at the user's personal computer.

23. The method of claim 21, wherein implementing the search strategy to search the travel website for the travel service satisfying the search criterion comprises emulating a human user's interaction with the travel website.

24. The method of claim 21, wherein searching the travel website comprises emulating a human user's interaction with the travel website.

25. A computer implemented method of searching for a travel service, comprising:
receiving a request to search for the travel service, wherein the request is associated with a search criterion and wherein the request is received at a user's personal computer from a remote device;
selecting a search strategy from a plurality of search strategies responsive to the request, wherein the search strategy identifies a travel website and navigation information associated with the travel website; and
implementing the search strategy to search the travel website for the travel service satisfying the search criterion using the navigation information, wherein searching the travel website is performed by the user's personal computer.

26. The method of claim 25, wherein the plurality of search strategies are stored locally at the user's personal computer.

27. The method of claim 25, wherein the remote device consists of at least one of:
a cell phone; and
a personal digital assistant.

28. The method of claim 25, wherein implementing the search strategy to search the travel website for the travel service satisfying the search criterion comprises emulating a human user's interaction with the travel website.

29. A computer implemented method of searching for a product, comprising:
receiving a request to search for the product at a user's personal computer, wherein the request is associated with a search criterion;
selecting a search strategy from a plurality of search strategies responsive to the request, wherein the search strategy identifies a website and navigation information associated with the website and wherein the search strategy is created by a website expert; and
implementing the search strategy to search the website for the product satisfying the search criterion using the navigation information, wherein searching the website is performed by the user's personal computer.

30. The method of claim 29, wherein the plurality of search strategies are stored locally at the user's personal computer.

31. The method of claim 29, wherein implementing the search strategy to search the website for the product satisfying the search criterion comprises emulating a human user's interaction with the website.

32. The method of claim 29, wherein implementing the search strategy to search the website for the product satisfying the search criterion comprises:
accessing a webpage associated with the website; and
parsing the website to identify a field, wherein the field consists of at least one of:
a link to a webpage associated with the product;
an input field for inputting a search parameter; and
a field including information associated with the product.

33. The method of claim 32, wherein implementing the search strategy further comprises entering the search parameter in the input field, wherein entering the search parameter in the input field is performed by the user's personal computer.

34. The method of claim 32, wherein implementing the search strategy further comprises extracting the information associated with the product, wherein extracting the information associated with the product is performed by the user's personal computer.

35. The method of claim 29, wherein the navigation information associated with the website consists of at least one of:
information associated with accessing the website;
a vocabulary associated with the website;
information associated with parsing the website;
information associated with data entry in the website; and
information associated with data extraction from the website.

36. The method of claim 29, wherein searching the website comprises emulating a human user's interaction with the website.

37. A travel service search system, comprising:
a communication module adapted to receive a request to search for a travel service, wherein the request is associated with a search criterion;
a search strategies module adapted to store a plurality of search strategies, wherein the search strategies module resides on a user's personal computer; and
a travel agent adapted to select a search strategy from the plurality of search strategies responsive to the request, wherein the search strategy identifies a travel website and navigation information associated with the travel website, and wherein the travel agent is further adapted to search the travel website for the travel service satisfying the search criterion, wherein the travel agent resides on the user's personal computer.

38. The travel service search system of claim 37, wherein the travel agent is adapted to select the search strategy based on the search criterion.

39. The travel service search system of claim 38, further comprising a user preferences module adapted to store travel preferences for a user, wherein the user preferences module resides on the user's personal computer and wherein selecting the search strategy based on the search criterion comprises selecting the search strategy based on at least one of the travel preferences.

40. The travel service search system of claim 37, wherein the system further comprising a travel server, the travel server including:
an expert interface module adapted to receive the search strategy from a travel website expert; and
a server strategies module adapted to store the search strategy received from the travel website expert, wherein the search strategies module receives the search strategy from the travel server.

41. The travel service search system of claim 40, wherein the expert interface module is adapted to receive updated search strategies from the travel website expert, wherein the server strategies module is adapted to store the updated search strategies, and wherein the search strategies module is adapted to receive the updated search strategies from the travel server.

42. The travel service search system of claim 41, wherein the search strategies module receives the updated search strategies at a frequency determined by at least one of:
a frequency of usage of the travel agent; and
a frequency of update of the travel website.

43. The travel service search system of claim 37, further comprising a search data module adapted to store search data associated with the request, wherein the search data module resides on the user's personal computer and wherein the search data module further comprises:
a search parameter module adapted to store a search parameter used by the travel agent to search the travel website for the travel service, wherein the search parameter is generated by a parameter generation module based on at least one of the search criterion and the search strategy; and
a search results module adapted to store information associated with the travel service.

44. A travel service search system, comprising:
a communication module adapted to receive a request to search for a travel service, wherein the request is associated with a search criterion;
a search strategies module adapted to store a plurality of search strategies;
a user preferences module adapted to store travel preferences; and
a travel agent adapted to select a search strategy from the plurality of search strategies based on the search criterion, wherein the search strategy identifies a travel website and navigation information associated with the travel website, wherein the travel agent is further adapted to search the travel website for the travel service satisfying the search criterion, and wherein the search strategies module, the user preferences module, and the travel agent reside on a user's personal computer.

45. The travel service search system of claim 44, wherein searching the travel website comprises emulating a human user's interaction with the travel website.

46. The travel service search system of claim 44, wherein selecting the search strategy from the plurality of search strategies based on the search criterion comprises selecting the search strategy from the plurality of search strategies based on the travel preferences.

47. The travel service search system of claim 44, further comprising a reporting module adapted to generate a report including information associated with the travel service satisfying the search criterion.

48. The travel service search system of claim 44, further comprising a reservation module adapted to direct the user to the travel website for reserving the travel service.

49. The travel service search system of claim 44, further comprising an itinerary module adapted to generate an itinerary for the travel service.

50. The travel service search system of claim 44, further comprising an itinerary module adapted to retrieve at least one of a map and driving directions associated with the travel service.

51. The travel service search system of claim 44, wherein the travel agent consists of at least one of the following modules for searching the travel website for the travel service:
a website navigation module adapted to access a webpage associated with the travel website;
a data entry module adapted to enter a search parameter in the travel website;
a website parsing module adapted to parse the travel website to identify a field, wherein the field consists of at least one of:
a link to a webpage including information associated with the travel service;
an input field for inputting the search parameter; and
a field including the information associated with the travel service; and
a data extraction module adapted to extract the information associated with the travel service; and
a data analysis module adapted to analyze the extracted data for identifying the travel service that satisfies the search criteria.

52. An automated product search system, comprising:
a communication module adapted to receive a request to search for a product, wherein the request is associated with a search criterion;
a user preferences module adapted to store product preferences for a user;
a product search agent adapted to select a search strategy from a plurality of search strategies responsive to the request, wherein the search strategy identifies a website and navigation information associated with the website, and wherein the product search agent is further adapted to search the website for the product satisfying the search criterion, wherein the user preferences module and the product search agent reside on the user's personal computer.

53. The automated product search system of claim 52, wherein selecting the search strategy from the plurality of search strategies responsive to the request comprises selecting the search strategy based on the user's product preferences.

54. The automated product search system of claim 52, wherein searching the website comprises emulating a human user's interaction with the website.

55. A computer implemented method of tracking current information associated with a travel service that satisfies a search criterion, wherein the travel service is associated with a search strategy, and wherein the search strategy identifies a travel website and navigation information associated with the travel website, the method comprising:
receiving an indication of the travel service;
periodically implementing the search strategy to track the current information associated with the travel service, wherein each periodic implementation of the search strategy comprises:
searching the travel website for the travel service that satisfies the search criterion using the navigation information associated with the travel website; and
retrieving from the travel website the current information associated with the travel service.

56. The method of claim 55, wherein periodically implementing the search strategy is performed by a user's personal computer.

57. The method of claim 55, wherein periodically implementing the search strategy to track the current information associated with the travel service further comprises:
determining whether the current information associated with the travel service satisfies a notification criterion; and
presenting the current information to a user if it satisfies the notification criterion.

58. The method of claim 57, wherein the notification criterion includes a specified change in the current information associated with the travel service in comparison with information previously associated with the travel service.

59. The method of claim 55, wherein the current information associated with the travel service consists of at least one of:
a current price associated with the travel service; and
a current availability associated with the travel service.

60. The method of claim 55, further comprising:
generating a search parameter used to search the travel website for the travel service, wherein the search parameter is generated based on the search criterion; and
caching the search parameter to facilitate the periodic implementation of the search strategy.

61. The method of claim 55, wherein the current information comprises a current price of the travel service, and wherein periodically implementing the search strategy to track the current information further comprises storing the current price retrieved from the travel website, the method further comprising:
generating a price trend indicator based on the stored current price for a plurality of implementations of the search strategy; and
presenting the price trend indicator to a user.

62. A system for tracking current information associated with a travel service that satisfies a search criterion, wherein the travel service is associated with a search strategy, and wherein the search strategy identifies a travel website and navigation information associated with the travel website, the system comprising:
a communication module adapted to receive an indication of the travel service;
a tracking module adapted to periodically implement the search strategy to track the current information associated with the travel service, wherein for each implementation of the search strategy the tracking module searches the travel website for the travel service that satisfies the search criterion using the navigation information associated with the travel website and retrieves from the travel website the current information associated with the travel service, and wherein the tracking module resides on a user's personal computer.

63. A computer implemented method of target advertising in a travel service search system, the method comprising:
receiving an indication of a travel service selected by a user;
receiving an indication of a travel preference of the user, wherein the travel preference of the user is stored locally at the user's personal computer; and
searching for an advertisement that is associated with the travel service and that satisfies the travel preference of the user, wherein searching for the advertisement is performed by the user's personal computer.

64. The method of claim 63, wherein receiving the indication of the travel preference of the user comprises determining the travel preference of the user based on at least one of:
the travel service selected by the user;
a travel service previously selected by the user; and
an advertisement selected by the user.

65. The method of claim 63, further comprising:
presenting the advertisement to the user; and
charging an advertising fee to a vendor associated with the advertisement.

66. The method of claim 63, further comprising:
retrieving an itinerary for the travel service selected by the user; and
presenting the advertisement to the user in conjunction with the itinerary.

67. The method of claim 63, wherein the travel service comprises an airline reservation, and wherein the advertisement associated with the travel service advertises at least one of:
a car rental at an airport associated with the airline reservation;
a hotel at an airport associated with the airline reservation; and
a recreation activity at a destination associated with the airline reservation.

68. The method of claim 63, wherein the travel service comprises a hotel room at a particular location, and wherein the advertisement associated with the travel service advertises at least one of:
a car rental near the particular location;
a restaurant near the particular location; and
a recreational activity near the particular location.

69. The method of claim 63, wherein the travel service is associated with a time period, and wherein the advertisement includes a discount coupon valid at some point during the time period.

70. A system for target advertising in a travel agent, comprising:
a communication module adapted to receive an indication of a travel service selected by a user and an indication of a travel preference of the user; and
an advertising module adapted to search for an advertisement that is associated with the travel service and that satisfies the travel preference of the user, wherein the advertising module resides on the user's personal computer.

71. The target advertising system of claim 70, further comprising a server advertising module adapted to store a plurality of advertisements, wherein the advertising module searches for the advertisement by requesting the server advertising module to search for the advertisement among the plurality of advertisements.

72. A computer implemented method of generating a unified travel itinerary, comprising:
receiving an indication of a plurality of travel services selected by a user, wherein the plurality of travel services are associated with a plurality of travel websites;
retrieving information associated with the plurality of travel services from the plurality of travel websites, wherein retrieving the information associated with the plurality of travel services is performed by the user's personal computer; and
generating the unified itinerary for the plurality of travel services based on the retrieved information.

73. The method of claim 72, further comprising presenting the unified travel itinerary to the user, wherein presenting the unified itinerary consists of at least one of:
displaying the unified itinerary on a screen; and
printing the unified itinerary.

74. The method of claim 72, further comprising:
retrieving an advertisement associated with at least one of the plurality of travel services selected by the user;
presenting the unified itinerary to the user; and
presenting the advertisement to the user in conjunction with the unified itinerary.

75. The method of claim 72, further comprising:
retrieving a map associated with at least one of the plurality of travel services selected by the user;
presenting the unified itinerary to the user; and
presenting the map to the user in conjunction with the unified itinerary.

76. The method of claim 72, further comprising:
retrieving driving directions associated with at least one of the plurality of travel services selected by the user;
presenting the unified itinerary to the user; and
presenting the driving directions to the user in conjunction with the unified itinerary.

77. A travel agent for generating a unified travel itinerary, comprising:
a communication module adapted to receive an indication of a plurality of travel services selected by a user, wherein the plurality of travel services are associated with a plurality of travel websites;
a search module adapted to retrieve information associated with each of the travel services from the plurality of travel websites, wherein the search module resides on the user's personal computer; and
an itinerary module adapted to generate the unified itinerary for the plurality of travel services by combining the retrieved information.
